(19) United States
(12) Patent Application Publication
(10) Pub. No.: US 2023/0195147 A1
(43) Pub. Date: Jun. 22, 2023

(54) LOAD-DEPENDENT POWER CONTROL FOR HAIR IRON HAVING CERAMIC HEATERS

(71) Applicant: LEXMARK INTERNATIONAL, INC., LEXINGTON, KY (US)

(72) Inventors: RUSSELL EDWARD LUCAS, LEXINGTON, KY (US); WILLIAM ALAN MENK, JR., LEXINGTON, KY (US); JERRY WAYNE SMITH, IRVINE, KY (US); ERYK ZAGORSKI, LEXINGTON, KY (US)

(21) Appl. No.: 18/071,975

(22) Filed: Nov. 30, 2022

Related U.S. Application Data
(60) Provisional application No. 63/292,615, filed on Dec. 22, 2021.

(51) Int. Cl. G05D 23/24; H02J 3/12; A45D 1/28; H05B 1/02

(52) U.S. Cl. CPC G05D 23/24; A45D 1/28; H02J 3/12; H05B 1/0255; A45D 2001/004

(57) ABSTRACT

Methods and apparatus include a hair iron having a controller and a heater between first and second arms movable relative to each other between open and closed positions. The controller connects or not the heater to a line voltage to heat hair when placed between the arms during use. A proportional-integral-derivative (PID) controller communicates with a thermistor measuring a current temperature of the heater and makes requests of the controller to operate the heater at a setpoint temperature. In various embodiments, the heater heats to full power during warm-up and operates thereafter at lower temperatures based on a reading of the line voltage and a time to adjust the current temperature to the desired setpoint temperature.

This application claims priority to U.S. Provisional Pat. Application No. 63/292,615, filed Dec. 22, 2021.

### BACKGROUND

### 1. Field of the Invention

The present disclosure relates to power control for hair irons. More particularly it relates to power control methods and apparatus for controlling the AC power delivered to a hair iron having ceramic heaters, the power control being dependent on the load of the heaters of the hair iron.

### 2. Description of Related Art

Many conventional hair irons, such as flat irons, straightening irons, curling irons, crimping irons, etc., suffer from heat lag, which results in lengthy times to heat irons for use and cool them afterwards. During these times, users often set their irons on countertops or the like which creates a safety risk, especially to children, who may accidentally contact them while hot. Additional safety risks also arise when users accidentally leave on irons when not in use. The inventors recognize a need for hair irons having fast heating and cooling, which tends to improve safety, but under appropriate power management conditions.

Hair irons draw power from an electrical power grid to operate, i.e., alternating current (AC) line power. In various geographies, countries supply power at a relatively low voltage, e.g., 115 VAC, or high voltage, e.g., 230 VAC. Manufacturers typically design their irons to operate at one voltage or the other. In conventional hair irons, and those having lower thermal mass power-on demand, excessive power is available for initial warm-up of the iron than is needed for styling human hair. Under certain use-conditions, such as an extremely slow swiping motion through hair tresses with a hair iron, more energy than necessary can be transferred to the hair of users. In these situations, hair can become dry and brittle. To date, no effective method exists of reducing the amount of unneeded power, and subsequent energy, available to the user after the warmup period of the iron has elapsed. The problem is exacerbated when applying high heat settings to hair of lesser weight per unit area (e.g., finer hair) than the design intent of various style settings available with particular hair irons. That is, the problem is worsened on fine hair with hair irons set for coarse hair and/or high temperature settings. The inventors recognize a need to overcome these and other problems.

### SUMMARY

A hair iron includes two longitudinally extending arms each having a ceramic heater. Users place hair between the heaters for heating and styling. A controller coordinates AC power delivered to the heaters. Thermistors provide current heater temperatures to the controller, whereby desired temperature responses become calculated based thereon. The responses include application to the heaters as a function of load. The algorithmic control was developed through experimentation utilizing multiple use-cases such that the power delivered to the heaters is dropped to a fraction of the power needed for initial device warmup. Timing is such that the reduced power level is forced during a fraction of the tress length used in styling. Adequate time is allotted to allow a “reset” or return to full power availability between styling strokes. Power is also fractionalized for each heat setting level, and for the fully specified voltage range of the iron. A fundamental behavior of the controller is such that if there exists a request for more than 25% power for more than two seconds, a constant percentage of total available power is output to the heaters depending on the input line voltage.

In other embodiments, a hair iron includes a first arm and a second arm movable relative to each other between an open position and a closed position. A distal segment of the first arm is spaced from a distal segment of the second arm in the open position. The distal segment of the first arm is positioned in close proximity to the distal segment of the second arm in the closed position. A contact surface is positioned on an exterior, such as an exterior of the distal segment, of the first arm for contacting hair during use. The first arm includes a heater having a ceramic substrate and an electrically resistive trace on the ceramic substrate, e.g., on an exterior face of the ceramic substrate. The electrically resistive trace is composed of an electrical resistor material. In some embodiments, the electrically resistive trace includes the electrical resistor material thick film printed on the exterior face of the ceramic substrate after firing of the ceramic substrate. The heater is positioned to supply heat generated by applying an electric current to the electrically resistive trace to the contact surface. Embodiments further include those wherein the heater includes one or more glass layers on the exterior face of the ceramic substrate that cover the electrically resistive trace for electrically insulating the electrically resistive trace.

### BRIEF DESCRIPTION OF THE DRAWINGS

The foregoing summary, as well as the following detailed description, is better understood when read in conjunction with the appended drawings. However, the invention is not limited to the specific methods and components disclosed herein. Like numerals represent like features in the drawings. In the views:

FIGS. 1A and 1B show a representative hair iron having load-dependent power control for ceramic heaters;

FIGS. 2A and 2B are views similar to FIGS. 1A and 1B having covers removed to reveal electronic components;

FIG. 3 is a diagrammatic schematic view of a load-dependent power control system of a hair iron;

FIGS. 4A and 4B are plan views of an inner face and an outer face, respectively, of a ceramic heater for use in a hair iron;

FIG. 5 is a cross-sectional view of the heater shown in FIGS. 4A and 4B taken along line 5-5 in FIG. 4A;

FIG. 6 is a state, flow diagram for controlling heating of heaters in a hair iron based upon load; and

FIG. 7 is a table showing results and comments upon testing the load-dependent dynamic power control of heaters herein.

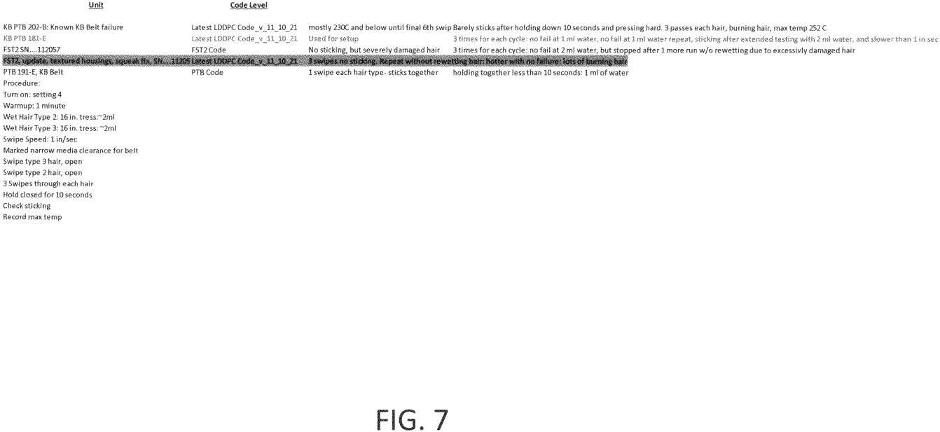

### DETAILED DESCRIPTION

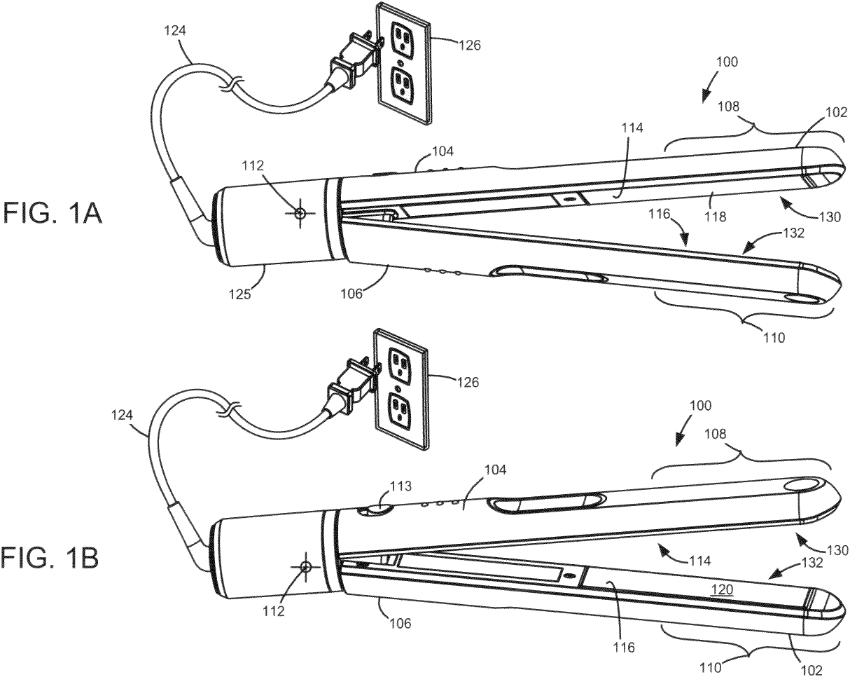

Referring now to the drawings and particularly to FIGS. 1A and 1B, a hair iron 100 is shown according to an example embodiment. Hair iron 100 includes an appliance such as a flat iron, straightening iron, curling iron, crimping iron, or other similar device that applies heat and pressure to hair in order to change the structure or appearance of the hair. Hair iron 100 has a housing 102 that forms the overall support structure of hair iron 100. The housing 102 may be composed of, for example, a plastic that is thermally insulative and electrically insulative and that possesses relatively high heat resistivity and dimensional stability and low thermal mass. Example plastics include polybutylene terephthalate (PBT) plastics, polycarbonate/acrylonitrile butadiene styrene (PC/ABS) plastics, polyethylene terephthalate (PET) plastics, including glass-filled versions of each. In addition to forming the overall support structure of hair iron 100, the housing 102 also provides electrical insulation and thermal insulation in order to provide a safe surface for the user to contact and hold during operation of hair iron 100.

Hair iron 100 further includes a pair of longitudinally extending arms 104, 106 that are movable between an open and closed position. Distal segments 108, 110 of arms 104, 106 are spaced apart from each other in the open position and are in contact, or close proximity with one another in the closed position. The arms clamshell or are pivotable relative to each other about a pivot axis 112 between the open position and the closed positions. Hair iron 100 may include a bias member (not shown), such as one or more springs, that biases one or both of arms 104, 106 toward the open position such that user actuation is required to overcome the bias applied to arms 104, 106 to bring arms 104, 106 together to the closed position. A lock 113 is provided to secure the arms in the closed position upon user manipulation.

Hair iron 100 includes a heater positioned on an inner side 114, 116 of one or both of arms 104, 106. Inner sides 114, 116 of arms 104, 106 include the portions of arms 104, 106 that face each other when arms 104, 106 are in the open and closed positions. In the example embodiment illustrated, each arm 104, 106 includes a respective heater 130, 132 opposed to one another on or within the arm 104, 106. Heaters 130, 132 supply heat to respective contact surfaces 118, 120 on arms 104, 106. Each contact surface 118, 120 is positioned on inner side 114, 116 of distal segment 108, 110 of the corresponding arm 104, 106. Contact surfaces 118, 120 may be formed directly by a surface of each heater 130, 132 or formed by a material covering each heater 130, 132, such as a shield or sleeve. Contact surfaces 118, 120 are positioned to directly contact and transfer heat to hair upon a user positioning hair between arms 104, 106 during use. Contact surfaces 118, 120 are positioned to mate against one another in a relatively flat orientation when arms 104, 106 are in the closed position in order to maximize the surface area available for contacting hair.

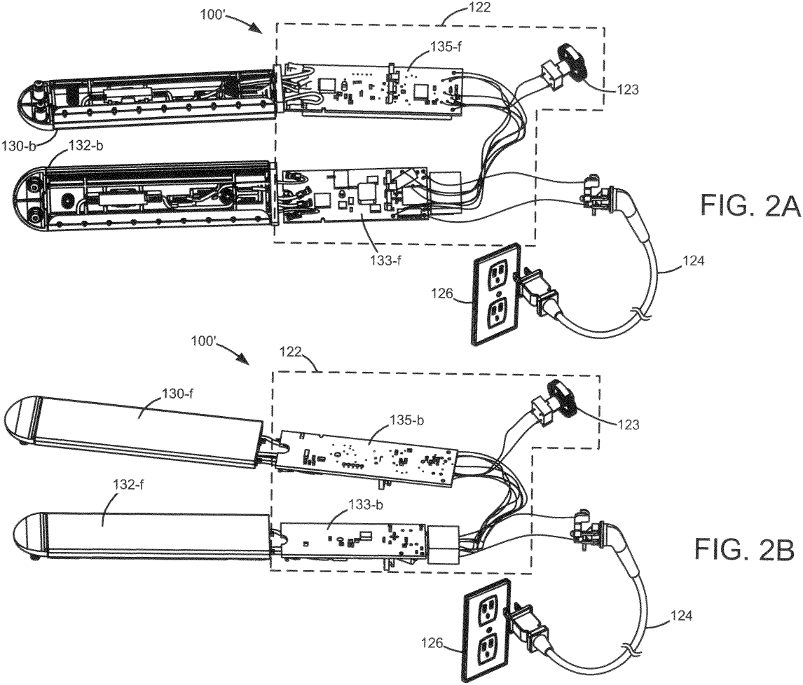

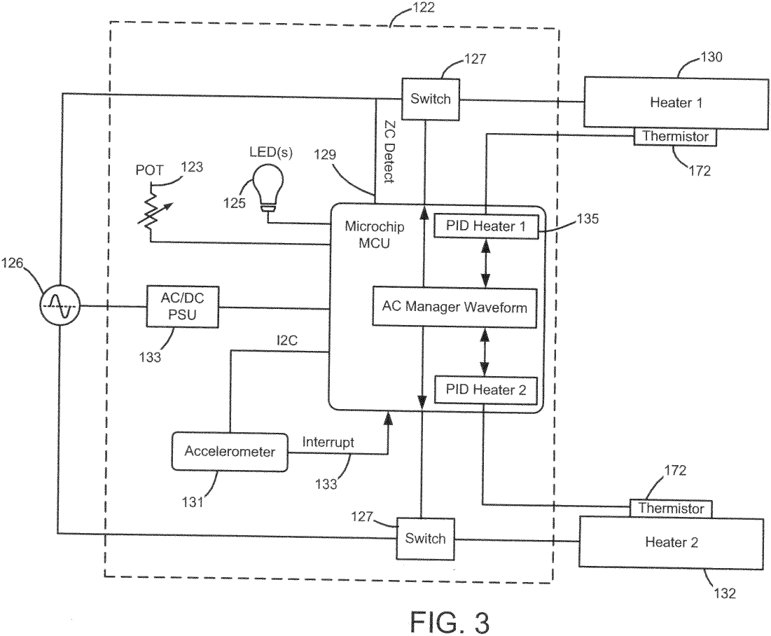

With reference to FIGS. 2A and 2B, hair iron 100′ (as seen in partial disassembled form) includes control circuitry 122 configured to control the power, thus the temperature, of each heater 130, 132. The control circuitry 122 in this design is bifurcated in the two arms of the hair iron, including a printed circuit board 133, 135 having a front (-f) and back (-b) sides. The PCB boards 133, 135 respectively relate to electrical circuit components for a power supply unit (PSU) and a microcontroller unit (MCU) that coordinate to selectively apply electrical current to the heaters 130, 132 (shown schematically in FIG. 3). The hair iron 100 further includes a power cord 124 for connecting hair iron 100 to an external line power or voltage source 126 to power the control circuitry 122 and heaters 130, 132. Amongst different geographies, the line power 126 is typically 115 VAC or 230 VAC.

With reference to FIG. 3, the regulation of line power 126 to the heaters 130, 132, includes control circuitry 122. A potentiometer 123 receives input from a user by twisting a handle 125 (FIG. 1A) of hair iron 100. The settings are varied, but twists of the handle generally relate to the hair iron 100 being off or powered on, with settings for fine, medium, thick, and coarse hair, corresponding to voltages of about 155 C, 175 C, 195 C, and 210 C to heat the heaters 130, 132. A light emitting diode (LED) 125 indicates to the user whether or not the hair iron 100 is powered on or off. Other settings are possible. One or more triacs or switches 127 connect the heaters 130, 132 to line power 126 under control of the MCU 135. The MCU turns on the triacs 127 when the AC voltage of the line power is at or near a zero-crossing (ZC) as provided on a zero-crossing detection circuit supplied at 129 to the MCU. An accelerometer 131 detects manipulation of the hair iron 100 and the MCU will stop heating of the heaters 130, 132 regardless of the potentiometer 123 setting if the MCU does not receive any interrupts 133 per a given period of time, say every 60 seconds. In this way, the controller knows that a user is manipulating the hair iron for use and not merely setting it aside. The thermistors 172 gather current temperature readings of the heaters 130, 132 that the MCU uses to control the set-points, temperature increases, temperature decreases, and the like, of the heaters. The thermistors provided input to the MCU per a given period of time, such as per every 1 msec. Line voltage varies per geography, e.g., 115 VAC or 230 VAC, and such is read by the MCU through a resistive divider circuit for controlling the power to the heaters. During use, based on the temperature difference of the measured heater temperature by the thermistor and the setpoint temperature, the PID (proportional-integral-derivative) controller calculates a desired temperature response to the current temperature to set the required heating power for each heater. The AC Manager Waveform stores pre-selected profiles of AC power, such that the controller generally adjusts PID gains in a manner to minimize warm up time, reduce ramp up temperature overshoot, and achieve tight steady state temperature control under load-dependent conditions.

Appreciating that the heaters 130, 132 are two independent heating elements of equal resistance and each has a current temperature feedback mechanism by way of the thermistor 172 to the controller 135, during use, the controller activates the switch 127 to control AC power delivery to the heaters. Using the AC zero-crossing feedback 129, the power delivery is synchronized precisely with the zero-crossings of the AC mains voltage waveform. This establishes the minimum unit of power delivery as a single half-cycle of the AC sinusoidal waveform. The controller modulates the current of each heater to achieve a desired temperature. This action is moderated by a temperature control loop (e.g. PID) running on the controller. That is, the control loop calculates a desired temperature response by way of a power level in units of percent, where 100% is equal to rated wattage of the heater. The fundamental period of heater power delivery in the following embodiments is based on half-cycles of AC sinusoidal power, such as eight half-cycles, but other numbers of half-cycles are possible to achieve other percentages of power levels.

In one embodiment, the controller causes the switch to connect heaters to the AC line voltage for an integer number of half-cycles within a given period. To achieve a power level percent (%) of 12.5 % (e.g., ⅛×100%), for example, one AC half-cycle of one-thru-eight total half-cycles of sinusoidal power is turned on to heat the heater. Similarly, to achieve a power level percent of 50%, four AC half-cycles 304 of one-thru-eight total half-cycles of sinusoidal power are turned on to the heat the heater (e.g., 4/8×100%). Similarly, too, all power level percentages of the heaters can be read from a table stored by the AC Manager Waveform, e.g., power level percentages 0%, 12.5%, 25%, 37.5%, 50%, 62.5%, 75%, 87.5%, and 100%. Of course, other percentages are possible.

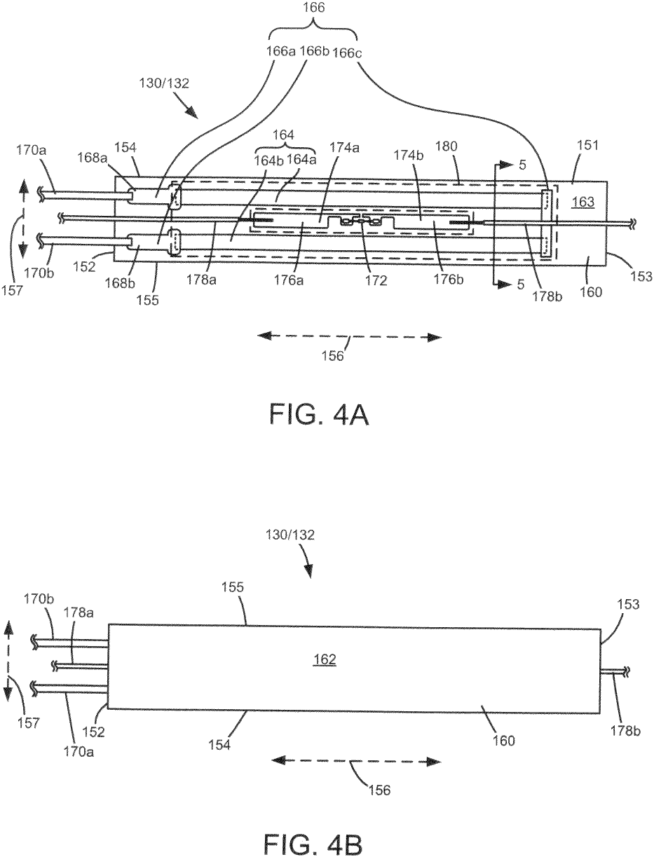

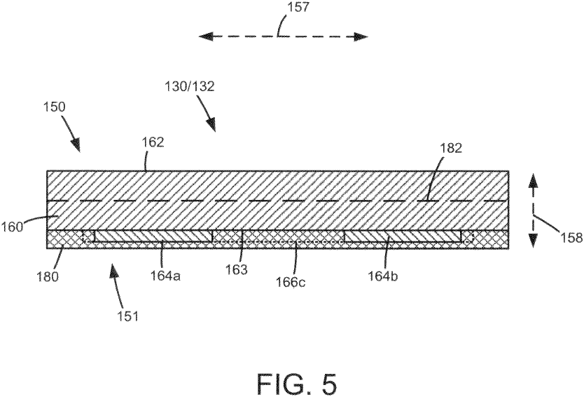

In FIGS. 4A and 4B, heaters 130 or 132 are detailed to show them as removed from their housing. They may or may not be identical to one another. FIG. 4A shows inner face 151 of heater 130/132, and FIG. 4B shows outer face 150 of heater 130/132. In the embodiment illustrated, outer face 150 and inner face 151 are bordered by four sides or edges 152, 153, 154, 155 each having a smaller surface area than outer face 150 and inner face 151. In this embodiment, heater 130/132 includes a longitudinal dimension 156 that extends from edge 152 to edge 153 and a lateral dimension 157 that extends from edge 154 to edge 155. Heater 130/132 also includes an overall thickness 158 (FIG. 5) measured from outer face 150 to inner face 151.

Heater 130/132 includes one or more layers of a ceramic substrate 160, such as aluminum oxide (e.g., commercially available 96% aluminum oxide ceramic). Where heater 130/132 includes a single layer of ceramic substrate 160, a thickness of ceramic substrate 160 may range from, for example, 0.5 mm to 1.5 mm, such as 1.0 mm. Where heater 130 includes multiple layers of ceramic substrate 160, each layer may have a thickness ranging from, for example, 0.5 mm to 1.0 mm, such as 0.635 mm. In some embodiments, a length of ceramic substrate along longitudinal dimension 156 may range from, for example, 80 mm to 120 mm. In some embodiments, a width of ceramic substrate 160 along lateral dimension 157 may range from, for example, 15 mm to 24 mm, such as 17 mm or 22.2 mm. Ceramic substrate 160 includes an outer face 162 that is oriented toward outer face 150 of heater 130/132 and an inner face 163 that is oriented toward inner face 151 of heater 130/132. Outer face 162 and inner face 163 of ceramic substrate 160 are positioned on exterior portions of ceramic substrate 160 such that if more than one layer of ceramic substrate 160 is used, outer face 162 and inner face 163 are positioned on opposed external faces of the ceramic substrate 160 rather than on interior or intermediate layers of ceramic substrate 160.

In the example embodiment illustrated, outer face 150 of heater 130/132 is formed by outer face 162 of ceramic substrate 160 as shown in FIG. 4B. In this embodiment, inner face 163 of ceramic substrate 160 includes a series of one or more electrically resistive traces 164 and electrically conductive traces 166 positioned thereon. Resistive traces 164 include a suitable electrical resistor material such as, for example, silver palladium (e.g., blended 70/30 silver palladium). Conductive traces 166 include a suitable electrical conductor material such as, for example, silver platinum. In the embodiment illustrated, resistive traces 164 and conductive traces 166 are applied to ceramic substrate 160 by way of thick film printing. For example, resistive traces 164 may include a resistor paste having a thickness of 10-13 microns when applied to ceramic substrate 160, and conductive traces 166 may include a conductor paste having a thickness of 9-15 microns when applied to ceramic substrate 160. Resistive traces 164 form the heating element of heater 130 and conductive traces 166 provide electrical connections to and between resistive traces 164 in order to supply an electrical current to each resistive trace 164 to generate heat.

In the example embodiment illustrated, heater 130/132 includes a pair of resistive traces 164a, 164b that extend substantially parallel to each other (and substantially parallel to edges 154, 155) along longitudinal dimension 156 of heater 130. Heater 130 also includes a pair of conductive traces 166a, 166b that each form a respective terminal 168a, 168b of heater 130. Cables or wires 170a, 170b are connected to terminals 168a, 168b in order to electrically connect resistive traces 164 and conductive traces 166 to, for example, control circuitry 122 and voltage source 126 in order to selectively close the circuit formed by resistive traces 164 and conductive traces 166 to generate heat. Conductive trace 166a directly contacts resistive trace 164a, and conductive trace 166b directly contacts resistive trace 164b. Conductive traces 166a, 166b are both positioned adjacent to edge 152 in the example embodiment illustrated, but conductive traces 166a, 166b may be positioned in other suitable locations on ceramic substrate 160 as desired. In this embodiment, heater 130/132 includes a third conductive trace 166c that electrically connects resistive trace 164a to resistive trace 164b. Portions of resistive traces 164a, 164b obscured beneath conductive traces 166a, 166b, 166c in FIG. 4A are shown in dotted line. In this embodiment, current input to heater 130/132 at, for example, terminal 168a by way of conductive trace 166a passes through, in order, resistive trace 164a, conductive trace 166c, resistive trace 164b, and conductive trace 164b where it is output from heater 130 at terminal 168b. Current input to heater 130 at terminal 168b travels in reverse along the same path.

In some embodiments, heater 130/132 includes a thermistor 172 positioned in close proximity to a surface of heater 130/132 in order to provide feedback regarding the current temperature of heater 130/132 to control circuitry 122. In some embodiments, thermistor 172 is positioned on inner face 163 of ceramic substrate 160. In the example embodiment illustrated, thermistor 172 is welded directly to inner face 163 of ceramic substrate 160. In this embodiment, heater 130/132 also includes a pair of conductive traces 174a, 174b that are each electrically connected to a respective terminal of thermistor 172 and that each form a respective terminal 176a, 176b. Cables or wires 178a, 178b are connected to terminals 176a, 176b in order to electrically connect thermistor 172 to, for example, control circuitry 122 in order to provide closed loop control of heater 130. In the embodiment illustrated, thermistor 172 is positioned at a central location of inner face 163 of ceramic substrate 160, between resistive traces 164a, 164b and midway from edge 152 to edge 153. In this embodiment, conductive traces 174a, 174b are also positioned between resistive traces 164a, 164b with conductive trace 174a positioned toward edge 152 from thermistor 172 and conductive trace 174b positioned toward edge 153 from thermistor 172. However, thermistor 172 and its corresponding conductive traces 174a, 174b may be positioned in other suitable locations on ceramic substrate 160 so long as they do not interfere with the positioning of resistive traces 164 and conductive traces 166.

FIG. 5 is a cross-sectional view of heater 130/132 taken along line 5-5 in FIG. 4A. With reference to FIGS. 4A, 4B and 5, in the embodiment illustrated, heater 130/132 includes one or more layers of printed glass 180 on inner face 163 of ceramic substrate 160. In the embodiment illustrated, glass 180 covers resistive traces 164a, 164b, conductive trace 166c, and portions of conductive traces 166a, 166b in order to electrically insulate such features to prevent electric shock or arcing. The borders of glass layer 180 are shown in dashed line in FIG. 4A. In this embodiment, glass 180 does not cover thermistor 172 or conductive traces 174a, 174b because the relatively low voltage applied to such features presents a lower risk of electric shock or arcing. An overall thickness of glass 180 may range from, for example, 70-80 microns. FIG. 5 shows glass 180 covering resistive traces 164a, 164b and adjacent portions of ceramic substrate 160 such that glass 180 forms the majority of inner face 151 of heater 130/132. Outer face 162 of ceramic substrate 160 is shown forming outer face 150 of heater 130/132 as discussed above. Conductive trace 166c, which is obscured from view in FIG. 5 by portions of glass 180, is shown in dotted line. FIG. 5 depicts a single layer of ceramic substrate 160. However, ceramic substrate 160 may include multiple layers as depicted by dashed line 182 in FIG. 5.

Heater 130/132 may be constructed by way of thick film printing. For example, in one embodiment, resistive traces 164 are printed on fired (not green state) ceramic substrate 160, which includes selectively applying a paste containing resistor material to ceramic substrate 160 through a patterned mesh screen with a squeegee or the like. The printed resistor is then allowed to settle on ceramic substrate 160 at room temperature. The ceramic substrate 160 having the printed resistor is then heated at, for example, approximately 140-160° C. for a total of approximately 30 minutes, including approximately 10-15 minutes at peak temperature and the remaining time ramping up to and down from the peak temperature, in order to dry the resistor paste and to temporarily fix resistive traces 164 in position. The ceramic substrate 160 having temporary resistive traces 164 is then heated at, for example, approximately 850° C. for a total of approximately one hour, including approximately 10 minutes at peak temperature and the remaining time ramping up to and down from the peak temperature, in order to permanently fix resistive traces 164 in position. Conductive traces 166 and 174a, 174b are then printed on ceramic substrate 160, which includes selectively applying a paste containing conductor material in the same manner as the resistor material. The ceramic substrate 160 having the printed resistor and conductor is then allowed to settle, dried and fired in the same manner as discussed above with respect to resistive traces 164 in order to permanently fix conductive traces 166 and 174a, 174b in position. Glass layer(s) 180 are then printed in substantially the same manner as the resistors and conductors, including allowing the glass layer(s) 180 to settle as well as drying and firing the glass layer(s) 180. In one embodiment, glass layer(s) 180 are fired at a peak temperature of approximately 810° C., slightly lower than the resistors and conductors. Thermistor 172 is then mounted to ceramic substrate 160 in a finishing operation with the terminals of thermistor 172 directly welded to conductive traces 174a, 174b.

Thick film printing resistive traces 164 and conductive traces 166 on fired ceramic substrate 160 provides more uniform resistive and conductive traces in comparison with conventional ceramic heaters, which include resistive and conductive traces printed on green state ceramic. The improved uniformity of resistive traces 164 and conductive traces 166 provides more uniform heating across contact surface 118 as well as more predictable heating of heater 130.

Preferably, heaters 130/132 are produced in an array for cost efficiency. Heaters are separated into individual heaters 130/132 after the construction of all heaters is completed, including firing of all components and any applicable finishing operations. In some embodiments, individual heaters are separated from the array by way of fiber laser scribing. Fiber laser scribing tends to provide a more uniform singulation surface having fewer microcracks along the separated edge in comparison with conventional carbon dioxide laser scribing.

It will be appreciated that the example embodiments illustrated and discussed above are not exhaustive and that the heater of the present disclosure may include resistive and conductive traces in many different geometries, including resistive traces on the outer face and/or the inner face of the heater, as desired. Other components (e.g., a thermistor) may be positioned on either the outer face or the inner face of the heater as desired.

The present disclosure does, however, provide a ceramic heater having a low thermal mass in comparison with the heaters of conventional hair irons. In particular, thick film printed resistive traces on an exterior face (outer or inner) of the ceramic substrate provides reduced thermal mass in comparison with resistive traces positioned internally between multiple sheets of ceramic. The use of a thin film, thermally conductive sleeve, such as a polyimide sleeve) also provides reduced thermal mass in comparison with metal holders, guides, etc. The low thermal mass of the ceramic heater of the present disclosure allows the heater, in some embodiments, to heat to an effective temperature for use in a matter of seconds (e.g., less than five seconds), significantly faster than conventional hair irons. The low thermal mass of the ceramic heater of the present disclosure also allows the heater, in some embodiments, to cool to a safe temperature after use in a matter of seconds (e.g., less than five seconds), again, significantly faster than conventional hair irons.

Further, embodiments of the hair iron of the present disclosure operate at a more precise and more uniform temperature than conventional hair irons because of the closed loop temperature control provided by the thermistor in combination with the relatively uniform thick film printed resistive and conductive traces. The low thermal mass of the ceramic heater and improved temperature control permit greater energy efficiency in comparison with conventional hair irons. The rapid warmup and cooldown times of the ceramic heater of the present disclosure also provide increased safety by reducing the amount of time the hair iron is hot but unused. The improved temperature control and temperature uniformity further increase safety by reducing the occurrence of overheating. The improved temperature control and temperature uniformity also improve the performance of the hair iron of the present disclosure.

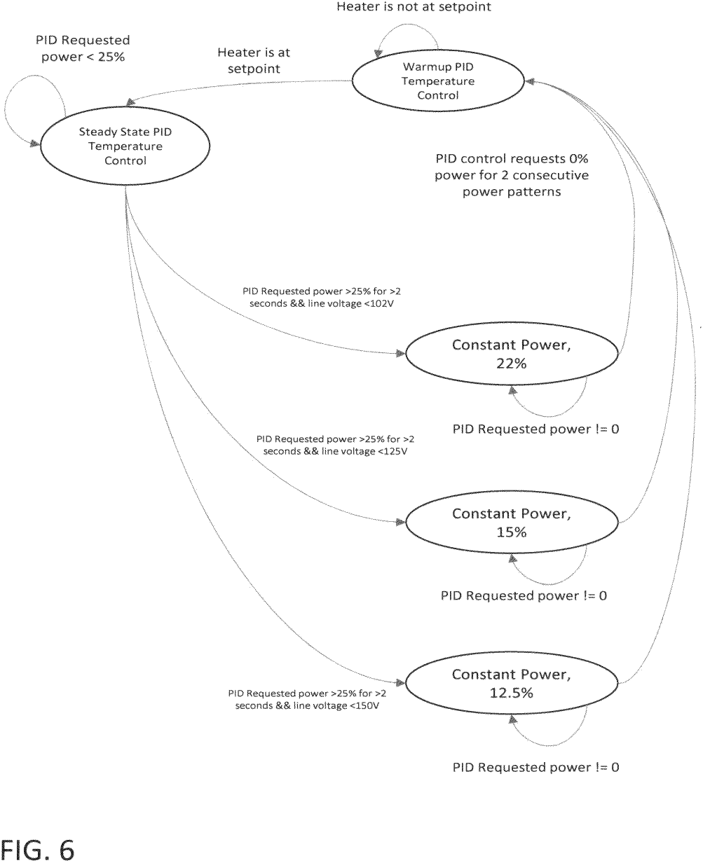

With reference to FIG. 6, a preferred implementation of control includes the fundamental behavior whereby, if the PID control loop is requesting more than 25% power for more than two seconds, the output to a given heater is a constant percentage of total available output power depending on the input line voltage, e.g., 115 or 230 VAC.

The inventors note there is no attempt to distinguish between thin vs. thicker hair, for example, but are simply adjusting away the power needed for initial warm-up in 5 or 6 seconds (full power is 250 W per side, 500 W total). As the inventors recognize that only a fraction of this power is needed to straighten, curl or otherwise style hair, the inventors limit power to 12.5% after more than 2 seconds of normal loading (requesting 25% or more power for more than 2 seconds). The timer resets whenever the two consecutive 0% power requests are made. The effect is to limit power 2 seconds into a hair-styling swipe. The algorithm adjusts percent power based on the voltage reading/measurement. The adjustment for rated line voltage of 115VAC is 15% power. Of course, the inventors can also change the time for reducing power - for instance, from 2 seconds to 3 seconds, as they can also change the percent power adjustment. This following algorithm is representative and assumed to be run repeatedly to control a heater.

### Algorithm

REQUESTED_POWER = pid_calculate(CURRENT_TEMPERATURE)
If CURRENT_STATE ==AT_TEMPERATURE
if REQUESTED_POWER > 25%
increment(POWER_COUNTER)
if POWER_COUNTER > 2 seconds
if LINE_VOLTAGE <102V
REQUESTED_POWER= 22%
else if LINE_VOLTAGE <125v
REQUESTED_POWER= 15%
else if LINE_VOLTAGE < 160V
REQUESTED_POWER = 12.5%
else
REQUESTED_POWER= 12.5%
if CURRENT_POWER == 0 AND PREVIOUS POWER == 0
POWER_COUNTER = 0
heat_at_power_percentage(REQUESTED_POWER)

The foregoing description illustrates various aspects of the present disclosure. It is not intended to be exhaustive. Rather, it is chosen to illustrate the principles of the present disclosure and its practical application to enable one of ordinary skill in the art to utilize the present disclosure, including its various modifications that naturally follow. All modifications and variations are contemplated within the scope of the present disclosure as determined by the appended claims. Relatively apparent modifications include combining one or more features of various embodiments with features of other embodiments.

1. With a hair iron having a controller and a heater between first and second arms movable relative to each other between an open and closed position, the hair iron connecting to a line voltage so the heater heats hair when placed between the arms during use, a method for controlling heating, comprising:
reading the line voltage;
determining a current temperature of the heater;
calculating a desired setpoint temperature of the heater; and
adjusting the current temperature of the heater to the desired setpoint temperature based on the read line voltage and a time to adjust the current temperature of the heater to the desired setpoint temperature.

2. The method of claim 1, further including warming up the heater with a rated full line power.

3. The method of claim 2, further including warming up the heater within five to six seconds.

4. The method of claim 2, adjusting the current temperature of the heater to a lower temperature after the warming up the heater.

5. The method of claim 4, wherein if the read line voltage is less than 102 VAC, and the time to adjust the current temperature is greater than two seconds, applying to the heater about 22% of the rated full line power.

6. The method of claim 5, further including requesting by a proportional-integral-derivative controller in communication with a thermistor measuring the current temperature of the heater more than 25% of the rated full line power.

7. The method of claim 4, wherein if the read line voltage is greater than about 102 VAC and less than about 125 VAC, and the time to adjust the current temperature is greater than two seconds, applying to the heater about 15% of the rated full line power.

8. The method of claim 7, further including requesting by a proportional-integral-derivative controller in communication with a thermistor measuring the current temperature of the heater more than 25% of the rated line power.

9. The method of claim 4, wherein if the read line voltage is greater than about 125 VAC and less than about 150 VAC, and the time to adjust the current temperature is greater than two seconds, applying to the heater about 12.5% of the rated full line power.

10. The method of claim 9, further including requesting by a proportional-integral-derivative controller in communication with a thermistor measuring the current temperature of the heater more than 25% of the rated line power.

11. The method of claim 4, further including requesting by a proportional-integral-derivative controller in communication with a thermistor measuring the current temperature of the heater less than 25% of the rated line power and maintaining the current temperature of the heater.

12. With a hair iron having a controller and a heater between first and second arms movable relative to each other between an open and closed position, the hair iron connecting to a line voltage so the heater heats hair when placed between the arms during use, the hair iron further including a proportional-integral-derivative (PID) controller in communication with the controller and a thermistor measuring a current temperature of the heater, a method for controlling heating, comprising:
reading the line voltage;
determining the current temperature of the heater;
calculating a desired setpoint temperature of the heater;
adjusting the current temperature of the heater to the desired setpoint temperature based on the read line voltage and a time to adjust the current temperature of the heater to the desired setpoint temperature based on a request from the PID controller; and
warming up the heater with a rated full line power.

13. The method of claim 12, wherein the time to adjust is two or three seconds.

14. The method of claim 12, wherein the warming up the heater occurs within five to six seconds.

15. The method of claim 12, wherein if the read line voltage is greater than about 125 VAC and less than about 150 VAC, applying to the heater about 12.5% of the rated full line power if the PID controller is requesting more than 25% of the rated line power.

16. The method of claim 12, wherein if the read line voltage is greater than about 102 VAC and less than about 125 VAC, applying to the heater about 15% of the rated full line power if the PID controller is requesting more than 25% of the rated line power.

17. The method of claim 12, wherein if the read line voltage is less than about 102 VAC, applying to the heater about 22% of the rated full line power if the PID controller is requesting more than 25% of the rated line power.

18. The method of claim 12, further including requesting by the PID controller requesting less than 25% of the rated line power.

19. The method of claim 18, further including maintaining the current temperature of the heater.

20. The method of claim 12, further including adjusting the current temperature of the heater to a lower temperature after the warming up the heater.
